(19) United States
(12) Patent Application Publication
(10) Pub. No.: US 2005/0162126 A1
(43) Pub. Date: Jul. 28, 2005

(54) Portable electronic appliance

(76) Inventor: Eriko Noguchi, Chiba-shi (JP)

Correspondence Address: ADAMS & WILKS, 31ST FLOOR, 50 BROADWAY, NEW YORK, NY, 10004, US

(21) Appl. No.: 11/004,787

(22) Filed: Dec. 3, 2004

(30) Foreign Application Priority Data
Dec. 24, 2003 (JP) 2003-427352

(51) Int. Cl. H02J 7/00

(52) U.S. Cl. 320/114

(57) ABSTRACT

To provide a potable electronic appliance capable of easily and reliably sensing light motion. A portable electronic appliance 1 having a flat casing includes a rotary weight main body portion capable of rotating in directions round a rotation center axis extending in a direction intersecting a main plane of the flat casing, a rotary weight structure portion having a magnet fitted to the rotary weight main body portion and a magnetic sensor for detecting the motion of the magnet in the directions resulting from the rotation of the rotary weight main body portion in the directions.

### BACKGROUND OF THE INVENTION

1. Field of the Invention

This invention relates to a portable electronic appliance.

2. Description of the Prior Art

Because a portable electronic appliance uses a battery as a power source, it is desired that battery consumption be limited to minimum. With such a background, a proposal has been made to provide a tilt sensor to the portable electronic appliance to limit battery consumption during non-use of the appliance and to quickly permit the supply of desired power to electric/electronic components at the start of use when the electric/electronic components having large power consumption under a standby state exist (JP-A-2001-183476 (leading part of paragraph No. 0015, etc), for example).

According to this JP-A-2001-183476, the tilt sensor has a moving element so moving as to follow up a tilt operation of a portable appliance main body and an ON or OFF signal is outputted whenever the moving element moves. However, the reference does not concretely describe a concrete construction of the tilt sensor as the essential technical matter. When the portable appliance main body is moved in practice on a table in a horizontal direction, for example, the tilt sensor sometimes fails to detect the movement of the appliance main body.

Incidentally, as means for detecting vibration, a counter module of a pedometer in which a spherical magnet suspended by a coil spring is arranged in a cylindrical guide tube extending in a vertical direction and a magnetic sensor element is arranged outside the guide tube has been proposed (JP-A-2001-184477 (FIG. 1 and its explanation portion)).

However, the technology disclosed in this JP-A-2001-184477 has extremely low sensitivity in practice to motion other than in the vertical direction and cannot be used so easily for detecting slight movement of the portable electronic appliance in an arbitrary direction.

The invention is completed in view of the problems described above and aims at providing a portable electronic appliance capable of sensing easily and reliably even slight motion.

### SUMMARY OF THE INVENTION

To accomplish the object described above, the invention provides a portable electronic appliance having a flat casing, comprising a rotary weight structure having a rotary weight main body portion capable of rotating round a rotation center axis extending in a direction intersecting a main plane of the flat casing and a magnet fitted to the rotary weight main body portion; and a magnetic sensor for detecting movement of the magnet resulting from the rotation of the rotary weight main body portion.

Since the portable electronic appliance according to the invention includes “a rotary weight main body portion capable of rotating round a rotation center axis extending in a direction intersecting a main plane of the flat casing”, the rotary weight main body portion can rotate round its rotation center axis when the casing of the portable electronic appliance moves even slightly. Speaking theoretically, the rotation of the rotary weight main body portion does not occur against the movement in a direction strictly parallel to the extending direction of the rotation center axis. Because it is possible to regard that the movement of the flat casing in the direction strictly parallel to the extending direction of the rotation center axis of the flat casing does not practically occur, however, the rotary weight main body portion can rotate round its rotation center axis when the portable electronic appliance is practically moved in whatever manner. Because “a magnet is fitted to the rotary weight main body portion”, the magnet can rotate with the rotary weight main body portion round its rotation center axis in whatever manner the portable electronic appliance is moved in practice. Furthermore, because the portable electronic appliance according to the invention includes “a magnetic sensor for detecting movement of the magnet resulting from the rotation of the rotary weight main body portion”, the magnetic sensor can detect the magnet rotating with the rotary weight main body portion round the rotation center axis in whatever manner the portable electronic appliance is practically moved. Therefore, in the portable electronic appliance according to the invention, it is possible to detect with high sensitivity the movement of the (casing of) portable electronic appliance in whatever manner the portable electronic appliance is practically moved.

The portable electronic appliance according to the invention is typically a wrist timepiece and a wrist fitting type portable electronic appliance such as a wearable electronic appliance fitted to an arm. In this case, horizontal movement or tilt of the casing of the portable electronic appliance occurs when a user of the portable electronic appliance pulls it forward or lifts it up by hand while the portable electronic appliance is removed from the arm and is put on a desk or shelf while the user is in bed, for example. In this case, the magnetic sensor can detect the rotation of the magnet with the rotation of the rotary weight main body portion resulting from this horizontal movement or tilt. Incidentally, even when the state under which the user does not move the arm while the portable electronic appliance is fitted to the arm continues for a certain time, for example, the magnetic sensor can detect the rotation of the magnet with the rotation of the rotary weight main body portion resulting from the movement of the arm or the casing of the electronic appliance when the user merely moves the arm to confirm associated display of the portable electronic appliance or touches the portable electronic appliance with a finger of the other hand.

However, the portable electronic appliance may be put into a pocket or a bag besides the wrist fitting type. In either case, the magnetic sensor can detect the rotation of the magnet in accordance with the rotation of the rotary weight main body portion resulting from the take-out operation from the accommodation position.

When the portable electronic appliance according to the invention includes at least one mechanical support structure selected from the group consisting of a battery frame having a cavity for accommodating a battery, a panel frame having a cavity for accommodating a display panel such as a liquid crystal display panel, a back cover and a fixing plate to which components are fixed, the rotation center axis of the rotary weight structure is typically supported by at least one support structure of the support structures at one of its ends. Incidentally, the portable electronic appliance need not always include all of the battery frame, the panel frame, the back cover and the fixing plate. For example, the back cover or the panel frame may be absent or the battery frame may be in common with other components. In other words, the rotation center axis of the rotary weight may be supported by an accommodation/holding frame body such as the battery frame or the panel frame, by a part of the casing such as the back cover or by a fixing plate as a rigid support structure arranged inside the casing so long as the support structure has sufficient rigidity and size to support the rotation of the rotary weight. In this case, the rotation center axis may be formed integrally with the rigid support structure or may be fixed to the rigid support structure.

The portable electronic appliance according to the invention may have a plurality of at least one of the magnetic sensor and the magnet. For example, the magnetic sensors may be disposed at a plurality of positions opposing the rotation path of the magnet. In this case, the movement of the magnet can be reliably detected even when the rotary weight main body portion does not rotate once round the rotation center axis due to extreme tilt of the casing of the portable electronic appliance in a specific direction. However, because the rotary weight main body portion can rotate sensitively to the tilt, only one magnetic sensor needs be disposed in many cases. When a plurality of magnetic sensors is disposed, too, three or four sensors disposed equidistantly in the circumferential direction are sufficient in many cases. When desired, however, a large number of sensors may be arranged with gaps among them in the circumferential direction. A plurality of rotary magnets may be fitted to the rotary weight main body portion in the circumferential direction with gaps among them with the rotation center axis as the center. In such a case, the magnets pass by the front surface of the magnetic sensor when the rotary weight main body portion rotates a little and the detection sensitivity can be easily improved.

Typically, in the portable electronic appliance according to the invention, the rotary weight main body portion includes a thin fan-shaped portion and a thick portion positioned remoter from the rotation center axis than the fan-shaped portion and thicker than the fan-shaped portion, the magnet is fitted to the fan-shaped portion and the magnetic sensor is fitted to an area capable of opposing the magnet. In this case, not only the occupying space and the weight of the rotary weight main body portion can be reduced to minimum but also the moment of inertia of the rotary weight main body portion can be improved. Therefore, high sensitivity detection can be made even when the acceleration the rotary weight main body portion receives is relatively small. Incidentally, the magnet typically has the thickness approximate to the thickness of the thin fan-shaped portion but may be thicker or thinner than the fan-shaped portion.

Typically, the portable electronic appliance according to the invention includes driving means operated by the magnetic sensor when the magnetic sensor detects approximation, alienation or passage of the magnet. In this case, the driving means can be reliably driven in accordance with the tilt of the portable electronic appliance. The driving means is typically driving means of electric/electronic components having large power consumption under the standby state and is typically a power source driving circuit for driving the power source of backlight of an EL(electroluminescence) panel, an acceleration sensor driving circuit for starting the sensing operation of an acceleration sensor or a driving circuit of a rotary switch for detecting the rotation of a rotary body such as a rotary bezel. However, the driving means may well be driving means of other kinds of components.

The magnetic sensor is constituted by a lead switch set to an ON state under the operation of a magnetic field, for example, but any sensor may be used so long as it fits to the arrangement environment and has high sensitivity of the magnetic field and small power consumption.

### BRIEF DESCRIPTION OF THE SEVERAL VIEWS OF THE DRAWINGS

A preferred form of the present invention is illustrated in the accompanying drawings in which:

FIG. 1 is an explanatory sectional view of a wrist timepiece type portable electronic appliance according to a preferred embodiment of the invention;

FIG. 2 is a partial enlarged explanatory plan view of a part of the portable electric appliance shown in FIG. 1;

FIG. 3 is an explanatory sectional view of a modified example of the wrist timepiece type portable electronic appliance shown in FIG. 1;

FIG. 4 is an explanatory sectional view of a wrist timepiece type portable electronic appliance according to another preferred embodiment of the invention;

FIG. 5 is an explanatory sectional view of a wrist timepiece type portable electronic appliance according to still another preferred embodiment of the invention; and

FIG. 6 is an explanatory sectional view of a wrist timepiece type portable electronic appliance according to still another preferred embodiment of the invention and is similar to FIG. 1.

### DETAILED DESCRIPTION OF THE PREFERRED EMBODIMENTS

Some preferred modes for carrying out the invention will be explained on the basis of preferred embodiments shown in the accompanying drawings.

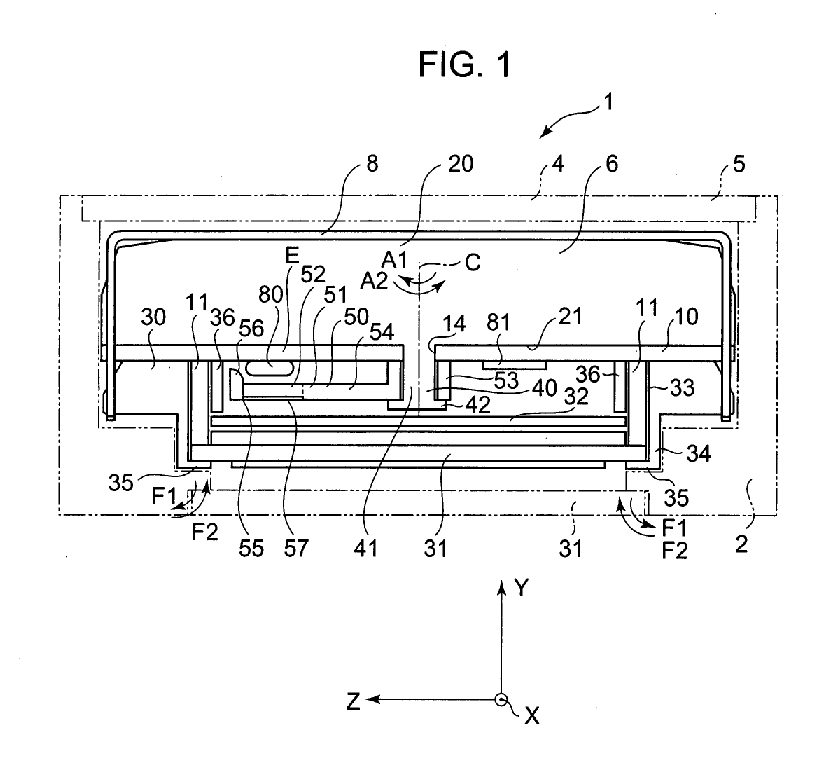

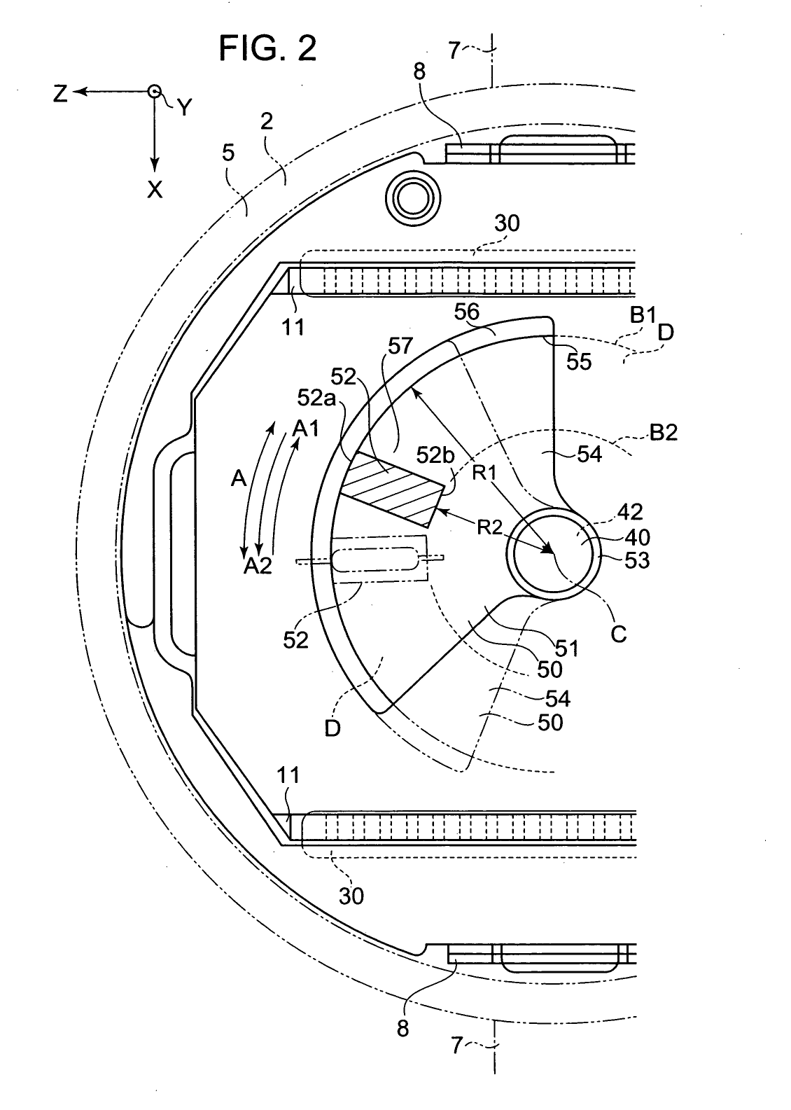

FIGS. 1 and 2 show a wrist fitting type portable electronic appliance 1 according to a preferred embodiment of the invention.

This portable type electronic appliance 1 includes various components constituting a main body 6 of the electronic appliance 1 inside a flat casing 5 including a drum 2, a front glass sheet 3 and a back cover 4 as indicated by imaginary lines in FIG. 1, for example. A three-dimensional orthogonal coordinates system (X-Y-Z) fixed to the electronic appliance 1 is hereby employed to simplify the explanation. The surface of the drawing is an X-Z plane and the direction of thickness of the appliance 1 is a Z direction. Therefore, the casing of the electronic appliance 1 is flat in the Z direction and expands in a direction parallel to an X-Y plane. A main plane of the casing 5 is therefore a plane parallel to the X-Y plane. One of the ends of bands 7 and 7 is fitted to the casing 5 as partially indicated by imaginary lines in FIG. 2 and a user fixes the bands 7 and 7 around the arm or wrist (not shown).

The main body 6 of the electronic appliance shown in FIG. 1 is constituted by integrating a circuit substrate 10 expanding along a plane parallel to the X-Y plane, a battery frame 20 formed of a thermoplastic resin, positioned on the back surface side of the circuit substrate 10 and equipped with a cavity for accommodating a battery (not shown) and a panel frame 30 for accommodating inside a cavity 33 an LCD (liquid crystal) panel 31 and an EL device 32 for giving backlight of the LCD panel 31 positioned on the front surface side of the circuit substrate 10, by using a spring 8 as fixing means. Incidentally, connectors 11 are interposed between the LCD panel 31 and the circuit substrate 10.

Incidentally, packaging is carried out by the steps of resiliently raising distal end bent portions 35 and 35 of a peripheral wall 34 of the cavity 33 of the panel frame 30 in an F1 direction, inserting the EL element 32 and the LCD panel 31 into the cavity 33 from the side of a distal end opening portion (opening portion at lower end in FIG. 1), putting them on support leg portions 36 and 36 inside the cavity 33 of the panel frame 30 and returning the distal end bent portions 35 to the positions shown in the drawing in an F2 direction.

The circuit substrate is equipped with a through-hole 14 and the battery frame 20 includes a cylindrical protuberance portion 40 extending in the Y direction on the surface 21 opposing the circuit substrate 10. The cylindrical protuberance portion 40 penetrates and protrudes through the through-hole 14 of the circuit substrate 10 and a rotary weight 50 is fitted to the projection 41 of the protuberance portion 40.

The rotary weight 50 includes a rotary weight main body portion 51 and a permanent magnet 52 fitted to the rotary weight main body portion 51 as can be seen from FIGS. 1 and 2. More specifically, the rotary weight main body portion 51 includes a hub portion 53 elongated in the Y direction and fitted to the projection 41 of the protuberance portion 40, a fan-shaped sheet-like portion 54 expanding outward in the radial direction inside the X-Z direction from an end portion of the hub portion 53 on the remote side of the circuit substrate 10 and an outer peripheral thick portion 56 extending in the Y direction towards the opposing surface of the circuit substrate 10 at an arc-shaped outer peripheral portion 55 of the sheet-like portion 54. Here, the radius of the rotary weight 50 is about 1 cm and the thickness of the hub portion 53 is from about 2 to about 3 mm. These values may be greater or smaller. The permanent magnet 52 is fixed to the center of the fan-shaped sheet-like portion 54 in the circumferential direction A in an outer area 57 in the radial direction of the fan-shaped sheet-like portion 54 of the rotary weight main body portion 51. In the example shown in the drawing, only one permanent magnet 52 is fitted but a plurality of permanent magnets 52 may well be fitted with spacing among them in the peripheral direction or the rotating directions A1 and A2.

Incidentally, a projecting end portion 42 of the projection 41 of the protuberance portion 40 penetrating and projecting through the hub portion 53 of the rotary weight main body 51 has an increased diameter and restricts a positioning error of the hub portion 53 with respect to the projection 41 in the Y direction. This large diameter projecting end portion 42 is formed by thermal caulking when the protuberance portion 40 is formed of a thermoplastic resin.

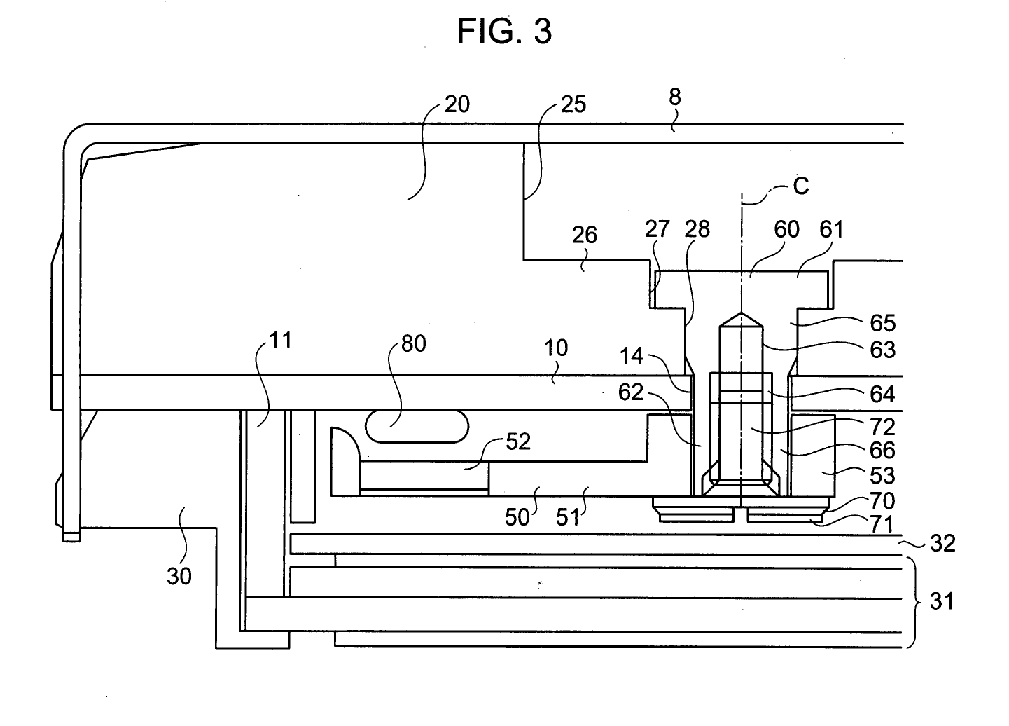

The positioning error of the hub portion 53 with respect to the projection 41 in the Y direction may be restricted by other arbitrary means, whenever desired. As shown in FIG. 3, f or example, the project ion may be formed of a pair of engagement members 60 and 70. One of the engagement members 60 has a large diameter head portion 61, a shaft portion 62 and a female screw portion 64 in a hole 63 that opens at the distal end of the shaft portion 62. The shaft portion 62 has a short medium-diameter shaft portion 65 and a small diameter shaft portion 66 having a length such that it substantially penetrates through the circuit substrate 10 and the hub portion 53 of the rotary weight main body portion 51. The battery frame 20 has a large diameter hole portion 27 in the bottom wall 26 of the battery accommodation cavity portion 25 and medium diameter hole portions 28 aligned with the large diameter hole portion 27. The circuit substrate 10 has a small diameter hole portion 14 having substantially the same diameter as that of the hole of the hub portion 53 at the position where it is aligned with the medium diameter hole portions 28. The other engagement member 70 has a large diameter head portion 71 and a shaft portion 72 having a male screw portion.

Therefore, in the case of the example shown in FIG. 3, the small diameter shaft portion 66 penetrates through the small diameter hole portion 14 of the circuit substrate 10, the medium diameter shaft portion 65 is fitted into the medium diameter hole portion 28 of the battery frame 20, the engagement members 60 are inserted into the holes 27, 28 and 14 so that the large diameter head portion 61 can be fitted to the large diameter hole portion 27 of the battery frame 20, the hub portion 53 of the rotary weight main body portion 51 is fitted to the projection of the small diameter shaft portion 66 of the engagement member 60 and the engagement member 70 is meshed with the engagement member 60. Needless to say, the assembly sequence may be different.

In any case, the length of the hub portion 53 in the Y direction is slightly smaller than the length of the penetration portion so that the hub portion 53 can rotate in the A1 and A2 directions round the penetration portion penetrating through the hub portion 53 of the projection portion.

In the portable electronic appliance 1, the rotary weight 50 can rotate in the A1 and A2 directions with the rotation center axis C as the center. The magnet 52 is movable along an annular area D encompassed by circles B1 and B2 respectively having radii R1 and R2 as the orbit described by a radial direction outer end portion 52a of the magnet 52 positioned at a position spaced apart by R1 from the center axis C and a radial direction inner end portion 52b of the magnet 52 positioned at a position spaced apart by R1 from the center axis C. When the portable electronic appliance 1 is tilted even a little, the rotary weight 50 is rotated in the A1 or A2 direction round the rotation center axis C.

On the other hand, a magnetic sensor 80 is arranged inside an area E corresponding to the annular area D of the circuit substrate 10. A main body of the magnetic sensor 80 directly detects whether or not the magnet 52 exists at a position opposing the magnetic sensor 80. However, because the magnetic sensor 80 needs to detect the movement of the magnet 52, the magnetic sensor 80 may well detect whether or not the magnet 52 reaches the opposing area (comes approximate to the opposing area) from outside the opposing area and whether or not the magnet 52 comes out of the opposing area (leaves the opposing area) from the opposing area or whether or not the magnet 52 passes through the opposing area opposing the magnetic sensor. Therefore, the magnetic sensor 80 includes the sensor main body and a detection portion for detecting the change of the state of the main body, for example. The detection portion may of course exist at a position spaced apart from the sensor main body. When the magnet 52 exists in the opposing area for a predetermined time, for example, an arrangement may be employed so that the magnet 52 can be regarded as being stationary.

The magnetic sensor 80 is connected to a driving control circuit 81 of an EL device 32 operating as a backlight of the LCD panel 31, for example. When the magnetic sensor 80 detects the rotation of the magnet 52 of the rotary weight 50, that is, the tilt of the portable electronic appliance 1, the magnetic sensor 80 drives the driving control circuit 81 to let the EL device 32 emit light and to make display of the LCD panel 31 recognizable.

Incidentally, the electronic appliance main body 6 of portable electric appliance 1 is formed when, for example, the panel frame 30 accommodating the EL device 32 and the LCD panel 31 inside the cavity 33 is fixed by the battery frame 20 integrating the circuit substrate 10 and the rotary weight 50 and the spring plate 8.

The operation of the wrist fitting type portable electronic appliance 1 constituted as described above will be explained.

When the wrist fitting type electronic appliance 1 is under the non-use state for a predetermined time in the electronic appliance 1, the driving control circuit 81 is constituted in such a manner that the supply of power to the EL panel 32 is stopped unless the driving signal is received from the magnetic sensor 80.

When the portable electronic appliance 1 is removed from the arm and is put on a desk or shelf while the user is in bed, the portable electronic appliance 1 is not tilted in practice and the detection signal (driving signal) is not generated from the magnetic sensor 80. Therefore, the supply of power to the EL device 32 of the portable electronic appliance 1 is kept stopped (or at a low level).

On the other hand, when the user lifts up the electronic appliance 1 by hand and touches the electronic appliance 1 or pulls forward the electronic appliance 1 to put it on the desk, etc, the casing 5 always and practically causes acceleration motion even to some extents in directions other than the extension direction of the axis C. This acceleration motion rotates or rocks the rotary weight 50 in the A1 or A2 direction. Therefore, the magnet 52 is similarly rotated or rocked in the A1 or A2 direction. The magnetic sensor 80 detects this motion of the magnet 52 resulting from the rotation or rocking. Therefore, the magnetic sensor 80 drives the driving circuit 81, allows the supply of power to the EL device 32 and makes the display of the LCD panel 31 recognizable. Because power consumption by the EL device 32 can be thus limited to minimum, life of the battery (not shown) can be extended to maximum.

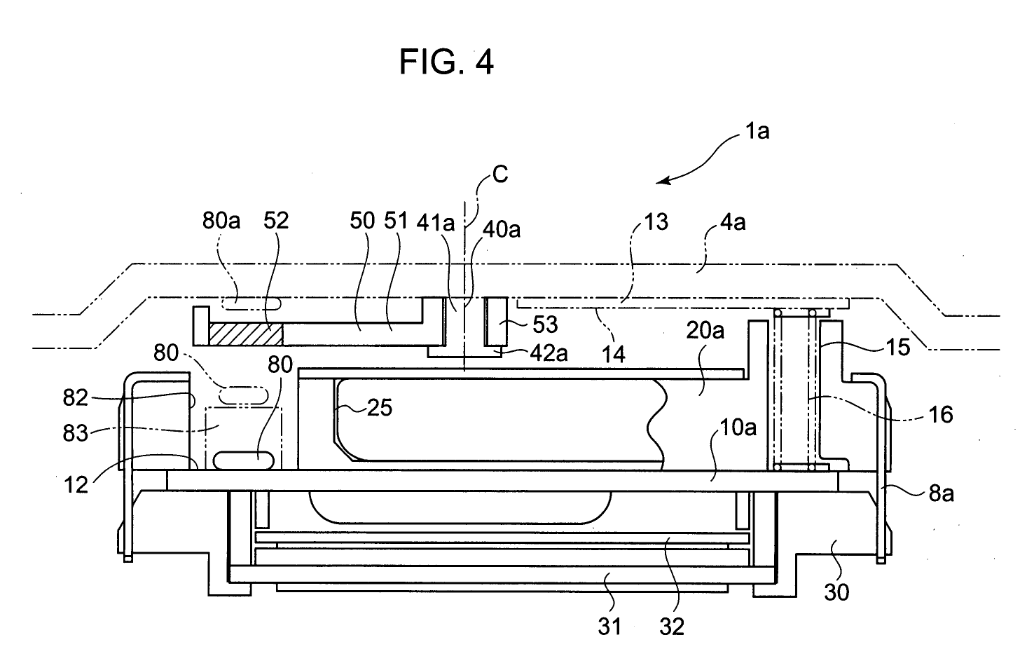

The rotary weight 50 may be fitted to other mechanical support structure other than the battery frame 20. For example, the rotary weight 50 may be fitted to the back cover 4a as in the portable electronic appliance 1a shown in FIG. 4. As for this portable electronic appliance 1a, the same reference numerals are assigned to the same members as those of the portable electronic appliances 1a shown in FIGS. 1 and 3. In the portable electronic appliance 1a, the suffix “a” is put to the elements or members which are substantially the same as those of the portable electronic appliance 1 shown in FIGS. 1 and 3 but a part of which is changed.

In the portable electronic appliance 1a, a protuberance portion 40a protruding from the inner surface of the back cover 4a has a shaft portion 41a and an engagement large diameter portion 42a and a hub portion 53 of the main body portion 51 of the rotary weight 50 is fitted to the shaft portion 41a. In this example, the back cover 4a and the protuberance portion 40a are formed of a metal, for example, and a distal end portion of the shaft portion 41a of a pin having a large diameter head portion 42a is fixed to the inner surface of the back cover 4a by welding, or the like. In the portable electronic appliance 1a shown in FIG. 4, the magnetic sensor 80 is packaged to a side 12 of the circuit substrate 10a facing the back cover 4a and an opening portion 82 is define in an area of a battery frame 20a in which the magnetic sensor 80 can oppose the magnet 52. Incidentally, in the example shown in FIG. 4, the magnetic sensor 80 is shown as if it were directly fitted to one of the main planes 12 of the circuit substrate 10a but it may fitted to the circuit substrate 10a through a desired socket or connector 83 having a height indicated by an imaginary line in FIG. 4 in such a manner as to further decrease a Y direction distance between the magnetic sensor 80 and the magnet 52 in consideration of the battery frame 20a. When an associated power cable and a signal line are connected or when a part of these conduction paths is formed on the back cover 4a, the magnetic sensor 80a may be arranged on the inner surface of the back cover 4a as indicated by an imaginary line.

In the case of this portable electronic appliance 1a, the rotary weight 50 can be arranged even when a large number of circuit elements packaged to the circuit substrate 10a and forming a circuit block exist. When the rotation center axis C of the rotary weight 50 is positioned to the center portion of the back cover 4a in the portable electronic appliance 1a, the radius of the main body portion 51 of the rotary weight 50 can be increased to maximum with respect to the casing 5a.

In the portable electronic appliance 1a shown in FIG. 4, a thin sheet-like piezoelectric element 13 operating as a sound generation body such as a buzzer is bonded to the inner surface of the back cover 4 and a coil spring-like contact electrode 16 fitted into a through-hole 15 formed in the battery frame 20 supplies desired power from the circuit substrate 10a to an inner surface side electrode 14 of the piezoelectric element 13. In this example, the center axis C of the rotary weight 50 is positioned to the center of the back cover 4a. For this reason, the piezoelectric element 13 is arranged in an area deviated from the center of the back cover 4a. The arrangement of the piezoelectric element 13 and the feed of power to the piezoelectric element 13 can be made similarly in the portable electronic appliances 1 shown in FIGS. 1 and 3, too. In the portable electronic appliances 1 shown in FIGS. 1 and 3, however, the piezoelectric element 13 may be arranged in the center area of the back cover 4.

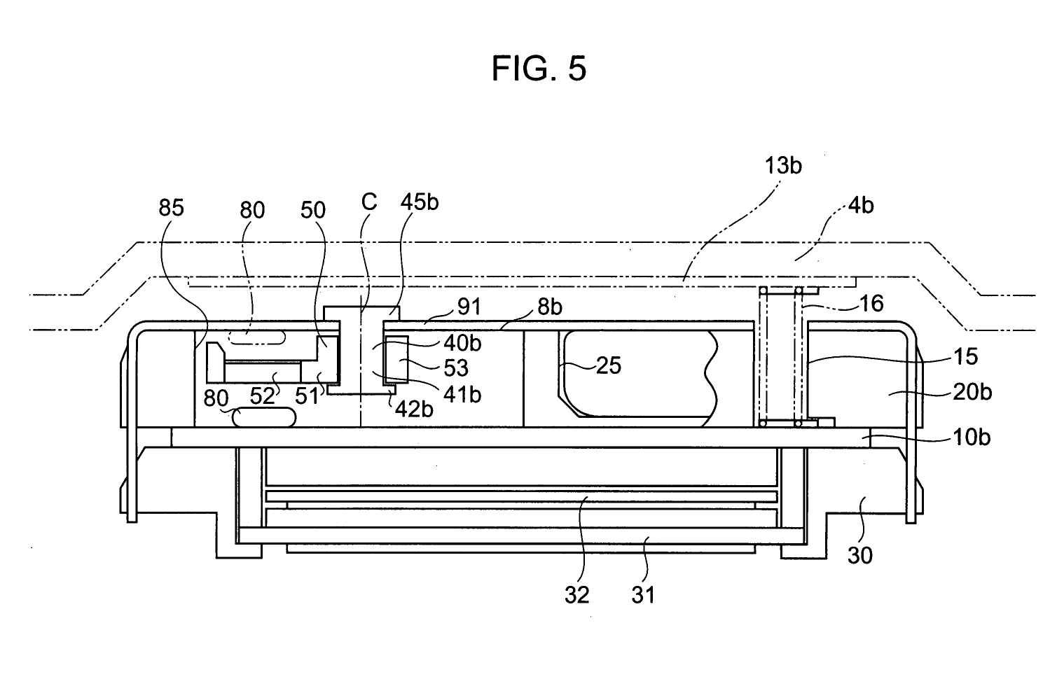

The rotary weight 50 may be fitted to a spring plate 8b operating as a fixing plate, for example, as shown in FIG. 5. As for the portable electronic appliance 1b shown in FIG. 5, the same reference numerals are assigned to elements or members as those in the portable electronic appliances 1 and 1a shown in FIGS. 1, 3 and 4. Though the portable electronic appliance 1b is substantially the same as the portable electronic appliances 1 and 1a shown in FIGS. 1, 3 and 4, the suffix “b” is put to the same reference numeral for those elements or members a part of which is changed.

A large circular opening portion 85 is formed in the battery frame 20b of the portable electronic appliance 1b and a protuberance portion 40b having a shaft portion 41b and a large diameter engagement portion 42b is formed at the center of an area of a large flat surface portion 91 of the spring plate 8b opposing the opening portion 85. A large diameter engagement portion 45b is formed at the upper end of the protuberance portion 40b, too. This protuberance portion 40b may be formed by a pair of engagement members 60 and 70 shown in FIG. 3 or of a resin that can be thermally caulked. In the case of this portable electronic appliance 1b, the thickness can be limited to minimum.

The magnetic sensor 80 is packaged to the circuit substrate 10b in the same way as described above. However, the magnetic sensor 80 may be arranged on the flat surface portion 91 of the spring plate 8b as indicated by imaginary line when connection of the power feed line and the signal line is made possible.

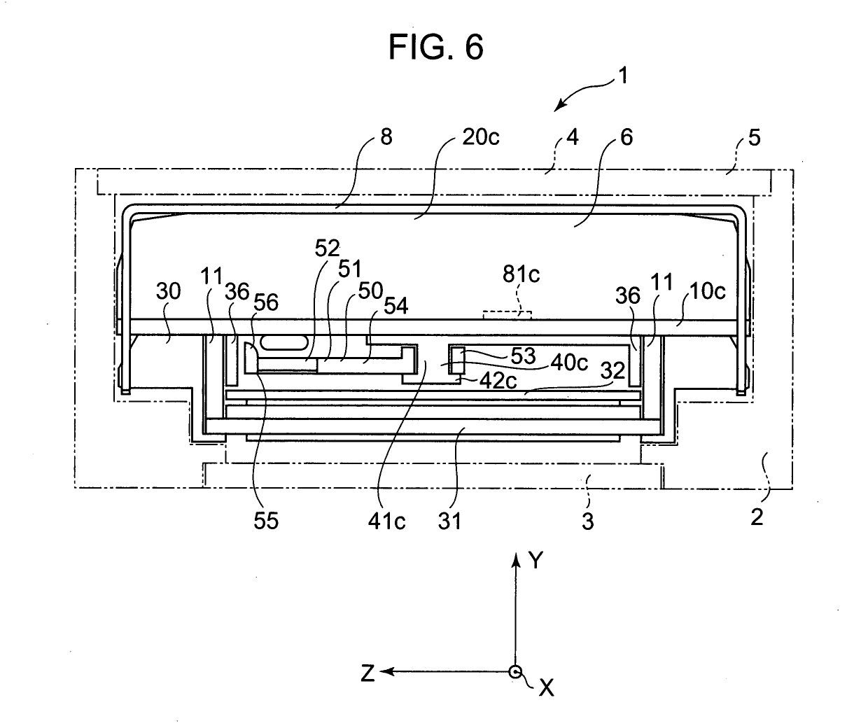

Furthermore, the rotary weight 50 may be fitted to the panel frame 30c as shown in FIG. 6. As for the portable electronic appliance 1c shown in FIG. 6, the same reference numerals are assigned to elements or members as those in the portable electronic appliance 1 shown in FIG. 1. The portable electronic appliance 1c is substantially the same as the portable electronic appliance 1 shown in FIG. 1, and the suffix “c” is put to the same reference numeral of those elements or members a part of which is changed. In the portable electronic appliance 1c shown in FIG. 6, a protuberance portion 40 protrudes from a center flat sheet-like portion 37 of the panel frame 30c coming into contact with the circuit substrate 1c and a large diameter engagement portion 42c is formed by thermal caulking or like means to the distal end of the shaft portion 41c of the protuberance portion 40c.

In any of the examples given above, a slide surface formation material layer or member may be formed or arranged on each end face itself of the hub portion 53 of the rotary weight 50 and/or an area coming into contact with the end face so that both end faces can be supported in such a manner as to be capable of sliding and rotating.

It would be obvious that this portable electronic appliance 1c can operate in the same way as the portable appliance 1 shown in FIG. 1.

In the description given above, the magnetic sensor 80 is typically packaged to the circuit substrate 10, 10a, 10b, 10c for the sake of convenience of wiring but when no limitation of wiring exists as to the arrangement of the magnetic sensor 80, the outer peripheral thick portion 56 of the rotary weight 50 typically protrudes towards the side of the magnetic sensor 80 (FIGS. 1, 3 and 6). In this way, the overall thickness of the rotary weight 50 and the magnetic sensor 80 can be limited to minimum.

In the portable electric apparatus 1, 1a, 1b, 1c of each of the embodiments shown in the drawing, the side in which the LCD panel 31 exists is positioned at the upper position and the side in which the back cover 4, 4a, 4b exists is positioned at the lower position under the ordinary use condition. Therefore, the outer peripheral thick portion 56 protrudes towards the fitting side of the shaft portion 42 positioned at the lower part under the ordinary use condition so that the centroid becomes lower but this may be opposite depending on cases.

Though the foregoing explanation is given on the example where the driving control circuit of the EL element is operated by the magnetic sensor in the wrist timepiece type portable electronic apparatus, the electric/electronic components operated by the magnetic sensor may be of any other types and the portable electronic appliance is not limited to the wrist timepiece type.

1. A portable electronic appliance having a flat casing, comprising:
a rotary weight structure body having a rotary weight main body portion capable of rotating round a rotation center axis extending in a direction intersecting a main plane of the flat casing and a magnet fitted to the rotary weight main body portion; and
a magnetic sensor for detecting movement of the magnet resulting from the rotation of the rotary weight main body portion.

2. A portable electronic appliance as defined in claim 1, which is so constituted as to be fitted to an arm.

3. A portable electronic appliance as defined in claim 1, which further includes at least one mechanical support structure selected from the group consisting of a battery frame having a cavity for accommodating a battery, a panel frame having a cavity for accommodating a display panel, a back cover and a fixing plate to which components are fixed, and wherein the rotation center axis of the rotary weight structure is supported at one of the ends thereof by at least one support structure of the support structures.

4. A portable electronic appliance as defined in claim 1, wherein the rotary weight main body portion includes a thin fan-shaped portion and a thick portion positioned remoter from the rotation center axis than the fan-shaped portion and thicker than the fan-shaped portion, the magnet is fitted to the fan-shaped portion and the magnetic sensor is fitted to an area capable of opposing the magnet.

5. A portable electronic appliance as defined in claim 1, which further includes driving means operated by the magnetic sensor when the magnetic sensor detects approximation, alienation or passage of the magnet.
